(19) United States
(12) Patent Application Publication
(10) Pub. No.: US 2016/0250992 A1
(43) Pub. Date: Sep. 1, 2016

(54) AIRBAG FOR A MOTOR VEHICLE

(71) Applicant: DAIMLER AG, Stuttgart (DE)

(72) Inventors: Ralf BOGENRIEDER, Stuttgart (DE); Christian BURCZYK, Stuttgart (DE); Andreas HIRTH, Dielheim (DE)

(21) Appl. No.: 15/028,555

(22) PCT Filed: Sep. 17, 2014
(86) PCT No.: PCT/EP2014/002521

§ 371 Date: Apr. 11, 2016

(30) Foreign Application Priority Data
Oct. 24, 2013 (DE) 102013017695.6

(51) Int. Cl. B60R 21/233; B60R 21/264; B60R 21/239

(52) U.S. Cl. CPC B60R 21/233; B60R 21/239; B60R 21/264; B60R 2021/003

(57) ABSTRACT

A motor vehicle airbag has a support structure that is moveable from a storage position into a support position, and at least one cover element by means of which a support volume of the airbag formed by the support structure in its support position is surrounded at least in regions. At least one separating element, which at least partially divides the support volume into at least two chambers, is arranged in the support volume. The separating element has at least one through-flow opening via which gas received in one of the chambers in the support position can be at least partially guided into the other chamber.

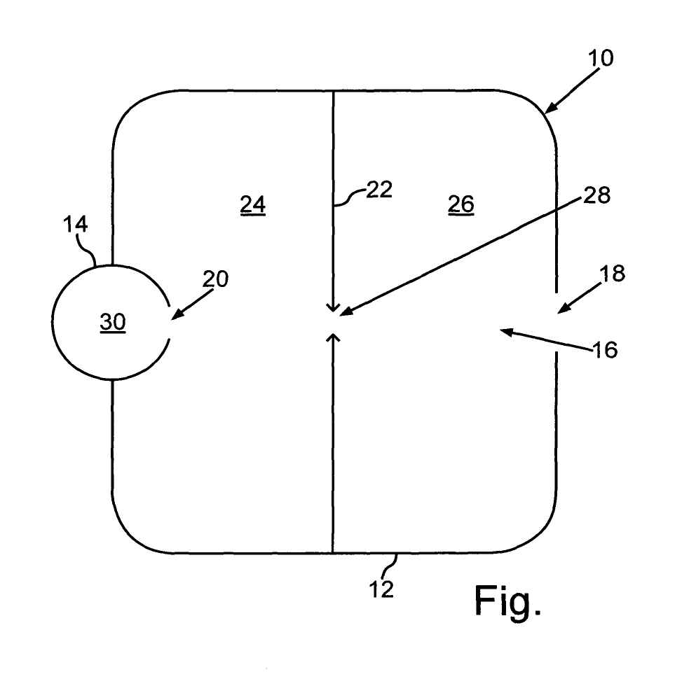

### BACKGROUND AND SUMMARY OF THE INVENTION

Exemplary embodiments of the invention relate to an airbag for a motor vehicle.

German patent document DE 10 2007 052 246 A1 discloses an airbag comprising a support structure that is moveable from a storage position into a support position. Here, the support structure comprises a plurality of volume elements that are able to be loaded, in other words able to be filled, with a medium, in particular a gaseous medium. By filling the volume elements with the medium, the support structure is moved from its storage position into its support position.

The airbag furthermore comprises at least one cover element. A support volume of the airbag formed by the support structure in its support position is surrounded at least in regions by means of the cover element. Since the support structure is formed in the manner of a framework, wherein the volume elements represent struts of the framework, the airbag is usually also referred to a framework bag.

In order to be able to advantageously catch and support a passenger striking the airbag in the case of force loading caused by an accident and therefore to protect him from severe injuries, it is advantageous if an airbag can be moved particularly quickly, in other words in a particularly short time, into the support position. This is readily possible in the case of a framework bag, since the volume of the support structure to be filled with the medium is substantially lower than the support volume. The framework bag can therefore not only be moved particularly quickly into the support position, but a particularly large support volume can also be achieved. The vehicle passenger can thereby, for example, also then be caught and supported if he is located in an unfavourable position relative to the airbag.

Exemplary embodiments of the present invention are directed to an airbag that allows a vehicle passenger to be caught and supported particularly advantageously.

In order to further develop an airbag for a motor vehicle, in particular a passenger motor vehicle, in such a way that a vehicle passenger can be caught and supported particularly advantageously in the event of a displacement caused by an accident, according to the invention at least one separating element is arranged in the support volume. The support volume is divided at least partially into at least two chambers or sub-volumes by the separating element. The separating element has at least one through-flow opening, via which a gas received in one of the chambers in the support position, in particular air, is able to be transferred at least partially into the other chamber.

If, for example, a vehicle passenger initially strikes the airbag, in other words the support structure and the cover element, in the case of force loading caused by an accident and a displacement resulting from this, in the region of one of the chambers, then the gas received in one of the chambers can flow through the through-flow opening and into the other chamber. A connected, cascade-shaped or cascade-type pressure distribution can thereby be achieved in the individual chambers. In particular it is possible to coordinate the two chambers to each other with regard to their behaviour when catching the vehicle passenger such that the vehicle passenger can be supported particularly effectively.

In particular, if the vehicle passenger strikes the other chamber in the further course of his displacement caused by an accident, then the vehicle passenger can also then be supported and caught particularly well. Since the gas can flow from one chamber into the other chamber, the air bag can be adjusted automatically in the course of the impact of the vehicle passenger with the airbag and thereby, for example, adapted to forces acting on the airbag. A so-called self-adaptability of the airbag is hereby able to be achieved, since the pressure distribution in the two chambers can be adjusted automatically.

Further advantages, features and details of the invention result from the following description of a preferred exemplary embodiment as well by means of the drawing. The features and feature combinations referred to above in the description as well as the features and feature combinations referred to below in the description of the figures and/or solely in the single figure are not only applicable in the respectively specified combination, but also in other combinations or alone without leaving the scope of the invention.

### BRIEF DESCRIPTION OF THE DRAWING FIGURE

The drawing shows, in the single FIGURE, a schematic side view of an airbag for a motor vehicle, having a support structure that is able moveable from a storage position into a support position and, in the support position, surrounds a support volume of the airbag, wherein at least one separating element dividing the support volume into two chambers is arranged in the support volume, the separating element having at least one through-flow opening for gas received in the support volume.

### DETAILED DESCRIPTION

The sole FIGURE shows, in sections, an airbag 10 for a motor vehicle, in particular a passenger motor vehicle. The airbag 10 is formed as a so-called framework bag and comprises a support structure having a plurality of volume elements. Of these volume elements, one volume element referred to with 14 can be recognised in the FIGURE. The airbag 10 also comprises at least one actuator (not illustrated) in the form of a gas generator. An explosion-like gas discharge is able to be caused by such a gas generator. The volume elements can thereby be filled with a medium in the form of a gas, in other words with a gaseous medium. By filling the volume elements or the support structure as a whole with the gaseous medium, the support structure is moved from a storage position into a support position. The airbag 10 can therefore catch and support a vehicle passenger in the support position if the vehicle passenger is displaced as a consequence of force loading caused by an accident.

In other words, gas can be blown into respective volumes of the volume elements by means of the gas generator, whereby the volume elements and therefore the support structure is or are inflated as a whole. Due to the inflation of the support structure, this is moved into its support position. In the support position, a support volume, which is referred to as a whole with 16, of the airbag 10 is formed by the support structure.

The airbag 10 is also referred to as a framework bag since the support structure is constructed to be framework-like. Here, the volume elements represent struts of the framework. The airbag 10 also comprises at least one cover element 12, by means of which the support volume 16 of the airbag 10 formed by the support structure in its support position is surrounded.

The respective volumes of the volume elements are advantageously connected to each other fluidically such that the air blown into one of the volume elements, for example, by means of the gas generator can flow into the corresponding other volume elements. A connected total volume of the support structure is created by this fluid connection of the individual volumes of the volume elements. This total volume must be inflated by the gas generator to move the support structure into the support position. This total volume is thereby substantially smaller than the support volume 16 formed by the support structure, such that the airbag 10 or the support structure can be moved particularly quickly, in other words in a short time or temporally before force loading caused by an accident, into the support position and can occupy a particularly large volume in the interior of the motor vehicle. The vehicle passenger can then also be caught and supported particularly advantageously if the vehicle passenger is located in an unfavourable position relative to the airbag 10.

The filling of the support structure with the gaseous medium occurs actively using the at least one gas generator. When moving from the storage position into the support position, the support volume 16 is filled at least partially and preferably at least predominantly with a gaseous medium in the form of air from the interior of the motor vehicle. This filling of the support volume 16 with air from the interior of the motor vehicle occurs, contrary to the active inflation of the support structure, at least substantially passively. The support volume 16 is successively enlarged by the unfolding of the support structure as a consequence of the inflation of the volume elements, whereby a vacuum is generated in the support volume 16 compared to the interior of the motor vehicle. Air is sucked into the support volume 16 at least substantially passively from the interior by this vacuum. For this purpose, the cover element 12 has at least one through-flow opening (not illustrated) via which air can flow into the support volume 16 from the interior of the motor vehicle.

In order to support the filling of the support volume 16 with gas, at least one further gas generator can be provided, by means of which air or gas is actively blown into the support volume 16. Alternatively or additionally, the support structure can have at least one through-flow opening 20, via which gas can flow from the support structure and into the support volume 16. As is recognisable from the the sole FIGURE, the through-flow opening 20 is presently provided in the volume element 14.

A higher pressure prevails in the support structure than in the support volume 16 due to the active inflation of the support structure. The support structure is therefore a high-pressure system, wherein the support volume 16, on the other hand, is a low-pressure system. The through-flow opening 20 allows gas to flow from the high-pressure system into the low-pressure system.

As can also be seen in the sole FIGURE, at least one separating element 22 is arranged in the support volume 16. The separating element 22 is, for example, connected to the volume element 14 and/or to the support structure. The separating element 22 is presently non-rigid, in other words flexible, and is formed from a textile. Preferably, the separating element 22 is formed from a fabric. Therefore, the separating element 22 can be a fabric layer. The separating element 22 at least partially divides the support volume 16 into at least two chambers 24, 26. The chamber 24 is thereby designed, in terms of the support position, to catch the thorax region of the vehicle passenger. Therefore, the chamber 24 is also referred to as the thorax chamber.

The chamber 26 is designed, in terms of the support position, to catch the head of the vehicle passenger. Therefore, the chamber 26 is also referred to as the head chamber. This means that the vehicle passenger strikes the chamber 24 with his thorax or at least with a predominant part of his thorax and the chamber 26 with his head during a displacement caused by an accident, for example forwards in the vehicle longitudinal direction. In the course of the displacement caused by an accident, the passenger can initially strike the thorax chamber with his thorax and subsequently the head chamber with his head. In terms of the support position, the thorax chamber, which belongs to the low-pressure system, has greater hardness than the head chamber which also belongs to the low-pressure system. Due to these different levels of hardness, the catching and support function of the airbag 10 can be adapted according to need to the different regions of the body of the vehicle passenger.

The separating element 22 thereby has at least one through-flow opening 28, via which the gas received in the chamber 24 in the support position is able to be at least partially transferred into the other chamber 26. The separating element 22 can also be provided with a plurality of through-flow openings. The chambers 24, 26 are connected fluidically to each other via the through-flow opening 28 or are able to be connected fluidically to each other such that the gaseous medium flows from the gas generator into the hard thorax chamber via the actual high-pressure system and can subsequently also flow into the soft head chamber via the through-flow opening 28.

A particularly advantageous support, in particular in the shoulder region of the vehicle passenger, can hereby be achieved. Additionally, an advantageous coordination opportunity of the support between the head and the shoulder-chest region is able to be achieved. Furthermore, a particularly effective use of the gaseous medium to inflate the support structure can thereby be achieved. Since the chambers 24, 26 are connected or able to be connected to each other fluidically, the passive filling of both the chamber 24 and the chamber 26 is supported by the gaseous medium, which initially inflates the support structure. Furthermore, a pressure distribution in the support volume 16 can be adjusted automatically, wherein a connected, cascade-shaped pressure distribution is able to be achieved in the individual chambers 24, 26.

The cover element 12 also has at least one outflow opening 18, via which the gas or air received in the support volume 16 in the support position can flow from the support volume 16 to the environment, in other words into the vehicle interior, if the vehicle passenger strikes the airbag 10. A particularly advantageous damping effect of the airbag 10 can hereby be achieved.

The through-flow opening 28 can be opened permanently, in other words in a sustained manner. Alternatively it is also conceivable that at least one valve element is allocated to the through-flow opening 28, said valve element being adjustable between a closed position, which seals the through-flow opening 28, and at least one open position, which at least partially releases the through-flow opening 28. The valve element blocks the through-flow opening 28 fluidically in the closed position such that the gas cannot flow from the chamber 24 into the chamber 26. This flowing is enabled in the open position.

A channel 30 is formed by the volume of the volume element 14, the channel 30 flowing into the chamber 24 via the through-flow opening 20. The channel 30 is thereby used to guide the gaseous medium from the actuator into the chamber 24. In other words, the gaseous medium flowing through the channel 30 and provided by the gas generator can flow from the channel 30 via the through-flow opening 20 and can flow into the chamber 24. Then at least one part of the gas can flow from the chamber 24 into the chamber 26 via the through-flow opening 28. If the vehicle passenger does not strike the airbag 10, then a flowing of the gas from the chamber 24 into the chamber 26 via the through-flow opening 28 does not take place or takes place only slightly. This flowing or the quantity of the gas flowing from the chamber 24 into the chamber 26 increases, however, if the passenger initially strikes the thorax chamber during his displacement caused by an accident.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-7. (canceled)

8. A motor vehicle airbag, comprising:
a support structure moveable from a storage position into a support position;
at least one cover by means of which a support volume of the airbag formed by the support structure in its support position is surrounded at least in regions;
at least one separator, which at least partially divides the support volume into at least two chambers, is arranged in the support volume, wherein the at least one separator has at least one through-flow opening via which a gas received in one of the at least two chambers in the support position is able to at least partially be transferred into the other of the at least two chambers.

9. The airbag of claim 8, wherein in the support position, one of the at least two chambers is arranged to catch a thorax region of a passenger of the motor vehicle and the other of the least two chambers is arranged to catch a head of the passenger.

10. The airbag of claim 8, wherein in the support position, one of the at least two chambers has a greater level of hardness than the other of the at least two chambers.

11. The airbag of claim 8, further comprising:
at least valve element arranged in the through-flow opening, wherein the valve is adjustable between a closed position sealing the through-flow opening and at least one open position that at least partially releases the through-flow opening.

12. The airbag of claim 8, wherein the separator is formed from textile.

13. The airbag of claim 12, wherein the textile is fabric.

14. The airbag of claim 8, wherein the separator is non-rigid.

15. The airbag of claim 8, further comprising:
at least one actuator, which is arranged to supply a gaseous medium into the support structure to move the support structure into the support position; and
at least one channel flowing into one of the at least two chambers to guide the gaseous medium from the actuator into the one of the at least two chambers.
